(19) United States
(12) Patent Application Publication
(10) Pub. No.: US 2014/0124612 A1
(43) Pub. Date: May 8, 2014

(54) MULTI-MODE VEHICLE

(71) Applicant: Peter V. Bitar, Anderson, IN (US)

(72) Inventor: Peter V. Bitar, Anderson, IN (US)

(21) Appl. No.: 13/667,211

(22) Filed: Nov. 2, 2012

(51) Int. Cl. B64C 39/00; B63B 35/34; B64C 25/32

(52) U.S. Cl. 244/2

(57) ABSTRACT

A multi-mode vehicle is disclosed that can be used in two or more of land, water and ground effect flight. The vehicle includes a first engine driving the vehicle's wheels and a second engine driving a fan. The vehicle includes removable wings, a removable horizontal stabilizer and a rudder. The second engine and fan, operating alone, provide insufficient thrust for the wings to lift the vehicle off the ground. The first and second engines, operating together, provide sufficient thrust for the wings to lift the vehicle into ground effect flight. The second engine and fan provide sufficient thrust for the vehicle to maintain ground effect flight.

### BACKGROUND

This disclosure relates to a multi-mode vehicle that can be used in two or more of land, water and ground effect flight.

### BRIEF DESCRIPTION OF THE DRAWINGS

FIG. 1 illustrates a perspective view of a vehicle.

FIG. 2 illustrates a side elevational view of the FIG. 1 vehicle.

FIG. 3 illustrates a front elevational view of the FIG. 1 vehicle.

FIG. 4 illustrates a top plan view of the FIG. 1 vehicle.

FIG. 5 illustrates a top plan view of the FIG. 1 vehicle incorporating a ground effect wing kit.

FIG. 6 illustrates the FIG. 1 vehicle incorporating an alternative ground effect wing kit.

FIG. 7 is a side elevational view of the FIG. 6 configuration.

FIG. 8 is a side elevational view of the FIG. 1 vehicle incorporating a pontoon kit.

FIG. 9 is a perspective view of the FIG. 1 vehicle incorporating a tip-jet rotor flying kit.

FIG. 10 is a side elevational of the FIG. 9 configuration.

FIG. 11 is a top plan view of the FIG. 9 configuration.

### DETAILED DESCRIPTION

Reference will now be made to certain embodiments and specific language will be used to describe the same. It will nevertheless be understood that no limitation of the scope of this disclosure and the claims are thereby intended, such alterations, further modifications and further applications of the principles described herein being contemplated as would normally occur to one skilled in the art to which this disclosure relates. In several figures, where there are the same or similar elements, those elements are designated with the same or similar reference numerals.

Note that the terminal end of any numeric lead lines in the drawings, when associated with any structure, process or landmark described below is intended to representatively identify and associate the described feature. The terminal end of lead lines are not intended, nor should be inferred, to delimit or define per se boundaries of the referenced structure, process or landmark, unless specifically stated as such or facially clear from the drawings and the context of the description of the figure.

Unless specifically stated as such or facially clear from the figure(s) and the context in which term(s) is/are used, all words should be given their common commercial and/or scientific meaning consistent with the context of the below disclosure.

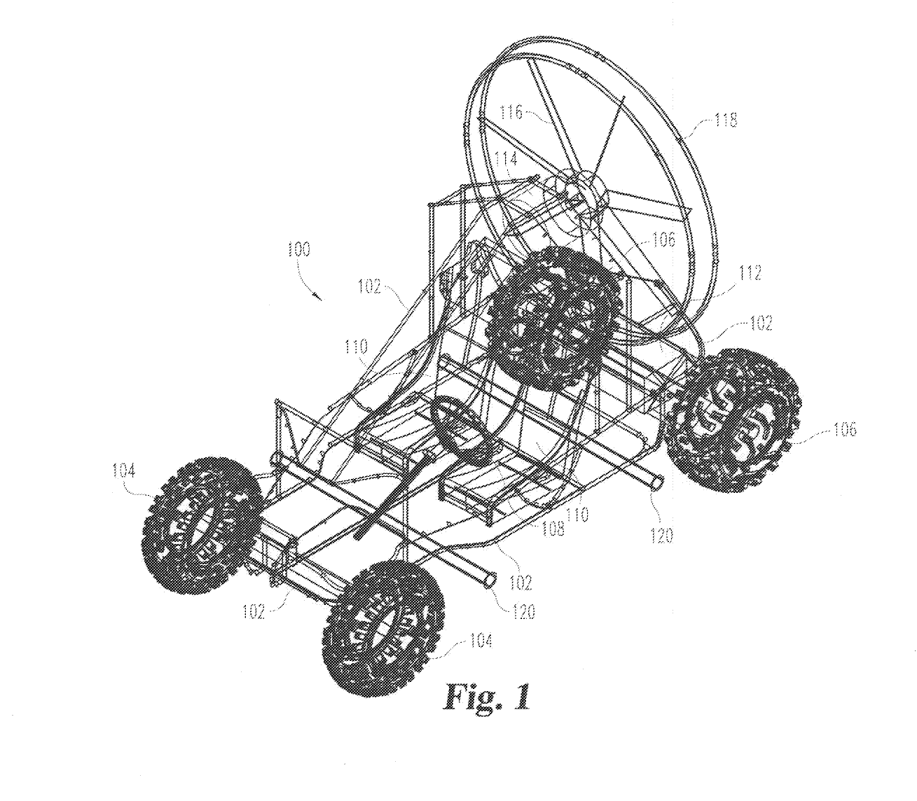

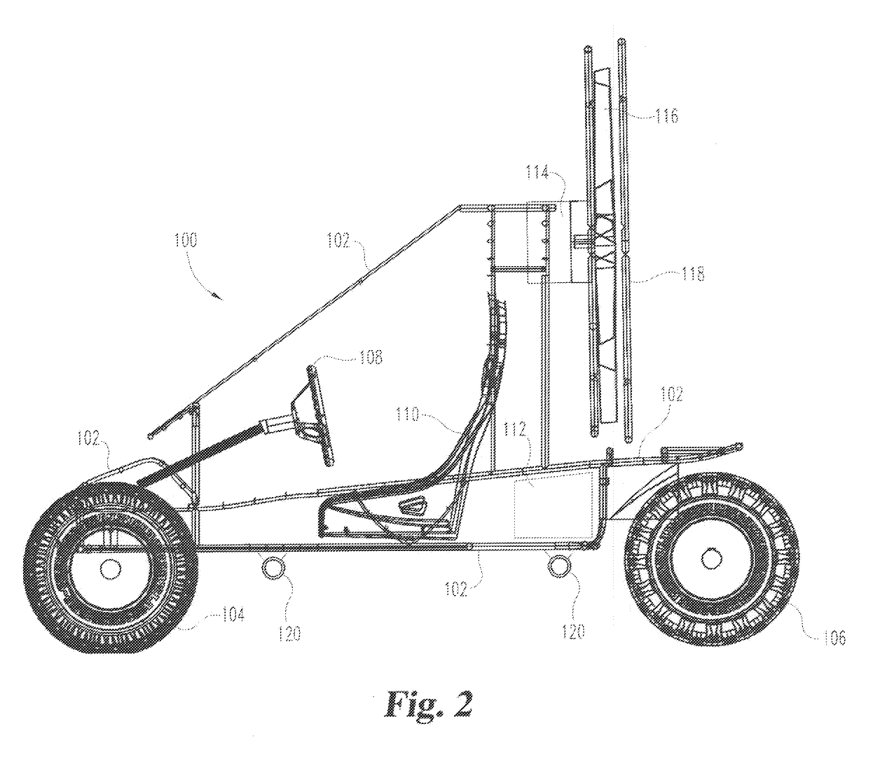

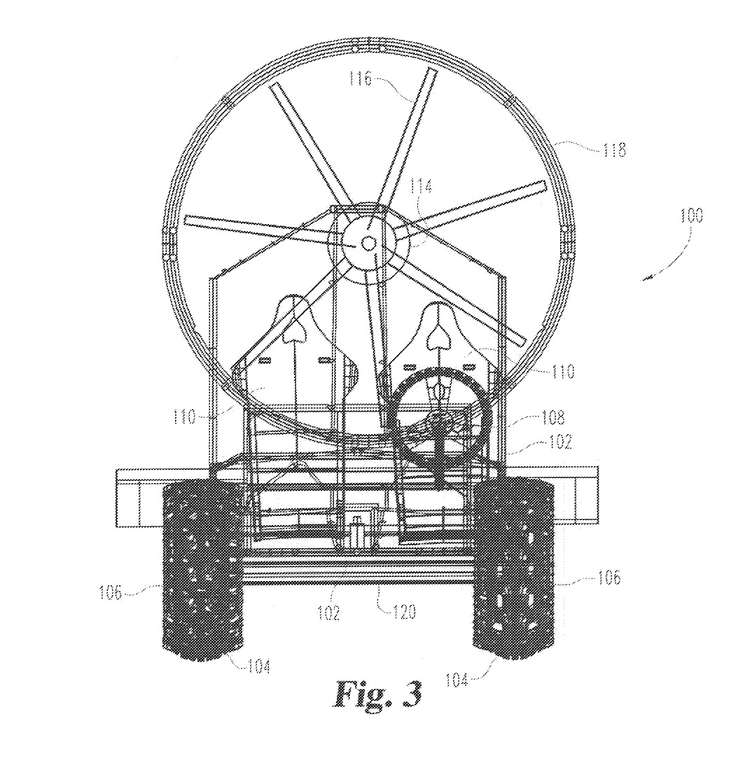

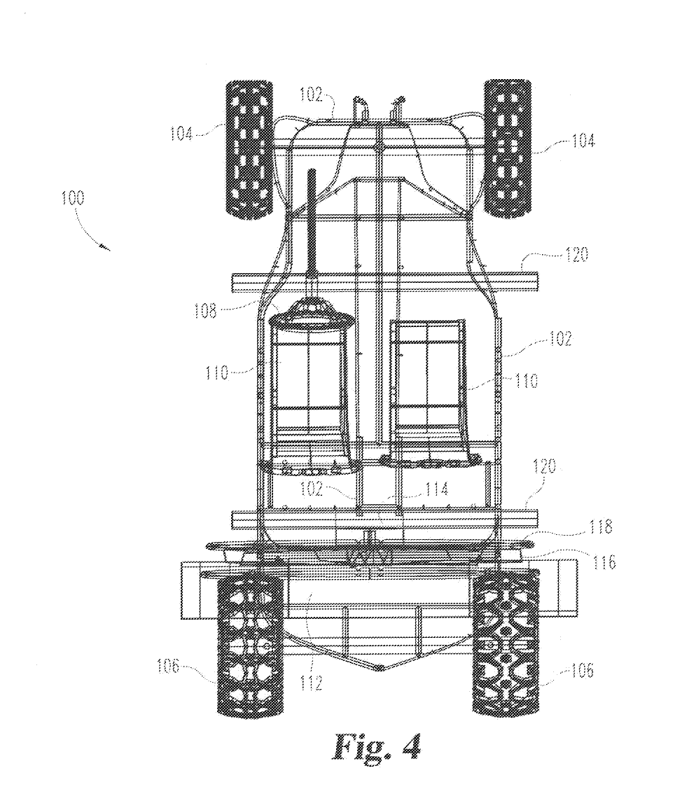

Referring to FIGS. 1-4, multimode vehicle 100 is illustrated. Vehicle 100 generally includes frame 102, front wheels 104, rear wheels 106, steering wheel 108, seats 110, engine 112, engine 114, fan 116, fan cage 118 and accessory mount supports 120.

Frame 102 generally includes the structural components that make-up vehicle 100, including any roll bar structures. Steering wheel 108 is linked to front wheels 104 to allow an operator to control the direction at front wheels 104 are pointing. This can be achieved by any means done in the art including, but limited to, rack and pinion system, a re-circulating ball mechanism, a worm and sector system or a capstan and bow string mechanism to name a few non-limiting examples.

Engine 112 is linked to drive rear wheels 106 through any transmission (not illustrated) known in the art including, but not limited to, belts and gears. The transmission can be a fixed ratio transmission or can be a variable transmission with multiple gear ratios. Engine 112 is controlled by a throttle (not illustrated). The throttle can take the form as a conventional foot pedal or a lever throttle or any other form of throttle may be used as desired.

Engine 114 is coupled to fan 116. In the illustrated embodiment fan 116 is coupled directly to the output of engine 114; however, a transmission system (not illustrated) could be optionally included. Any type of transmission known in the art may optionally be used including, but not limited to, a fixed ratio transmission or a variable transmission with multiple transmission ratios. Engine 114 is controlled with a second throttle (not illustrated). The second throttle may also be in the form of a foot pedal or a hand lever or any other form of throttle desired.

Fan cage 118 surrounds the operating envelope of fan 116. Fan cage 118 may optionally be augmented with mesh or netting structures to limit access to fan 116 from outside of fan cage 118.

Accessory mount supports 120 are attached to the bottom portion of front frame 102 and may be used as described below to attach accessories to vehicle 100 including, but not limited to, wings or pontoons.

Vehicle 100 is configured as a dune buggy and may be operated using either engine 112 and/or engine 114 to provide propulsion. Operating both engines 112 and 114 at full throttle provide higher velocity than operating either engine 112 or engine 114 at full throttle alone.

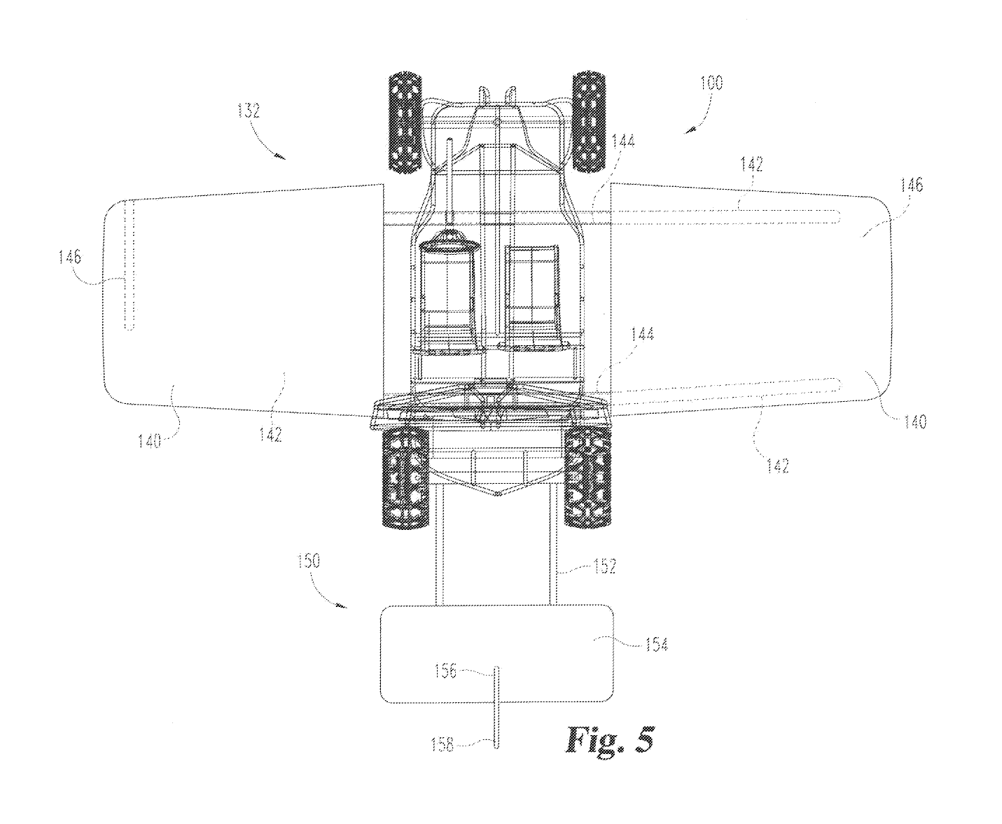

Referring now to FIG. 5, vehicle 100 is illustrated with flying kit 130 attached. Flying kit 130 includes wings 140 and tail assembly 150. Wings 140 include spars 142 passing through a portion of length of wing 140 and forming projections 144 that are constructed and arranged to extend into accessory mount supports 120 on vehicle 100. Wings 140 may be attached to vehicle 100 by inserting projections 144 into accessory mount supports 120 and then fixing them in place, for example, by inserting and securing a bolt through accessory mount supports 120 and projections 144. In addition, a fabric may be attached to vehicle 100 (not illustrated) that may optionally be zipped to fabric on the outer surface of wings 140. Wings 140 may be constructed using any materials desired. One example of construction is use of aluminum spars 142, fiberglass wing tips, a wooden internal structure and an external skin covered by black rubber sheeting.

Wings 140 may also optionally include skid-arms 146 positioned under the leading edge of wings 140 near the outer tip of wings 140. Skid-arms 146 are flexible rods constructed and arranged to absorb and deflect impact of the wing tip against the ground and to push the wing upward. Use of skid-arms 146 may help prevent cart wheeling in the event a wing tip strikes the ground.

Tail assembly 150 includes tail supports 152, horizontal stabilizer 154, vertical stabilizer 156 and rudder 158. Tail supports 152 couple horizontal stabilizer 154 to frame 102 and/or fan case 118. Rudder 158 pivots on vertical stabilizer 156 and its relative pivot position is controlled by the operator (not illustrated). Any desired means to control rudder 158 may be used including, but not limited to, rudder pedals, lever, linkage by cable, a mechanical linkage and/or a motor driven fly-by-wire system with a motor pivoted rudder 158.

Wings 140 are designed for use with a particular configuration of vehicle 100 to allow vehicle 100 to fly in ground effect. Ground effect refers to the phenomenon that occurs when a wing is flying at or below an altitude that is approximately equivalent to the chord length of the wing (the shape of the airfoil also affects the maximum altitude of ground effect). In ground effect, the ground interrupts wing tip vortices and down wash behind the wing. This results in lower induced drag which increases the Lift to Drag (L/D) ratio of the wing. The influence of ground effect on induced drag decreases with altitude, so available thrust may also affect the maximum altitude a particular vehicle can travel in ground effect.

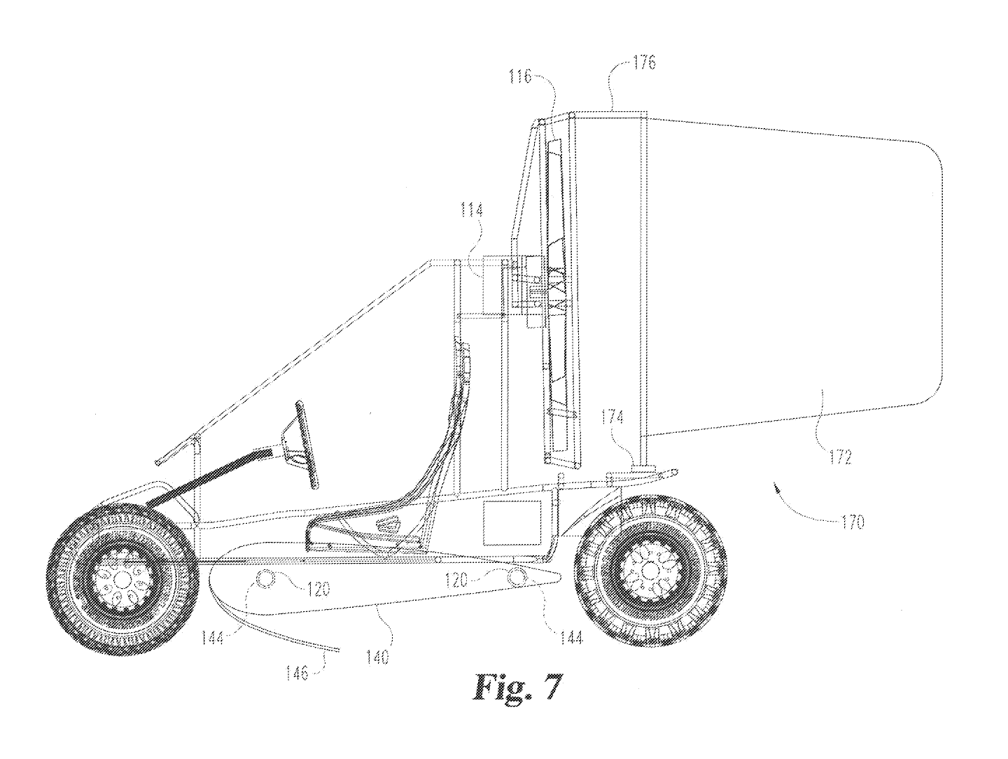

Wings 140 may include a cross section with an airfoil design optimized for operation in ground effect. As shown in FIG. 7, wings 140 may be mounted to vehicle 100 near the bottom of vehicle 100 to maximize ground effect.

Flying kit 130 is designed to allow vehicle 100 to fly through ground effect, but at the same time being unable to lift vehicle 100 into free flight (flight out of ground effect). These design considerations also extend to the configuration of fan 116 and engine 114. That is to say that maximum thrust generated by fan 116 and/or the maximum lift generated by wings 140 are insufficient for vehicle 100 to enter free flight under normal operating conditions.

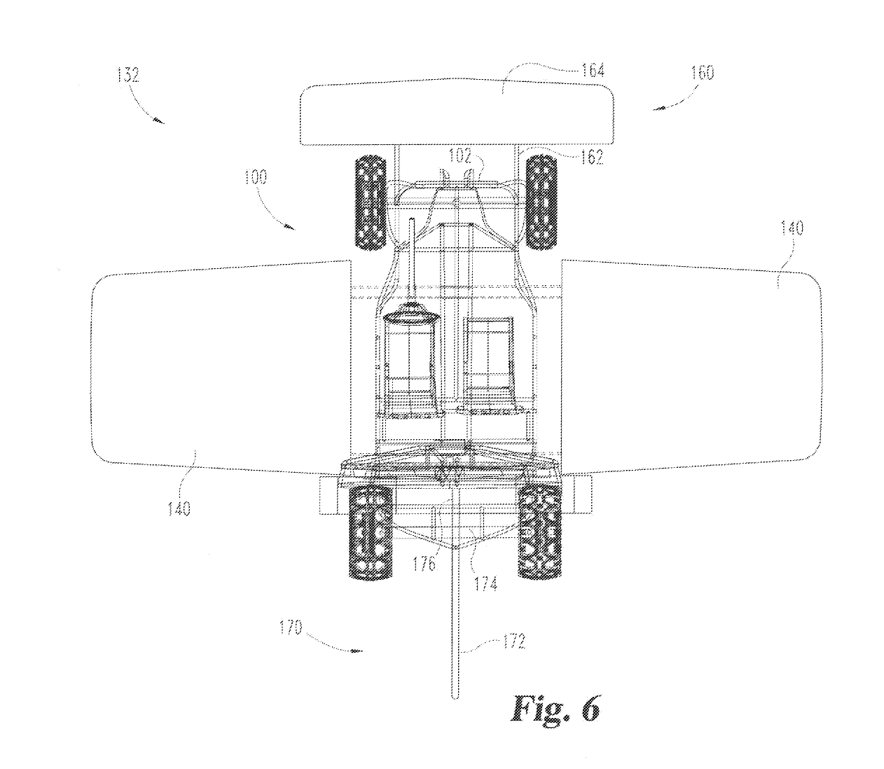

Referring now to FIG. 6, vehicle 100 is illustrated with flying kit 132 attached. Flying kit 132 includes wings 140, canard assembly 160 and rudder assembly 170.

Canard assembly 160 includes canard supports 162 and horizontal stabilizer 164. Canard supports 162 attach horizontal stabilizer 164 to frame 102.

Rudder assembly 170 includes rudder 172 and mounting brackets 174 and 176. Mounting bracket 174 is attached to frame 102 and mounting bracket 176 is attached to fan cage 118. Together they support rudder 172 and allow rudder to pivot. Pivoting of rudder 172 is controlled by any mean known in the art including, but not limited to, a gear and pulley system, a mechanical linkage or a motor actuated system. The control interface for rudder 172 may also be any means known in the art including, but not limited to, rudder foot pedals or a hand lever. Alternatively, rudder 172 may optionally be controlled by steering wheel 108. Rudder assembly 172 may be permanently attached to vehicle 100 or may be configured to be removable.

In the embodiments illustrated in FIGS. 5-7 incorporating flying kits 130 and 132, no elevator ailerons are used. Because vehicle 100 may only fly in ground effect, pitch and attitude stability may come from the lift slope difference between wings 140 and horizontal stabilizers 154 or 164, including the size of horizontal stabilizers 154 or 164 compared to wings 140. Altitude may be controlled by the throttle for engine 114 or by otherwise controlling the thrust generated by fan 116, e.g., varying the blade pitch of fan 116.

While not illustrated, it is possible to optionally incorporate ailerons and/or elevators may optionally be incorporated into wings 140 and/or horizontal stabilizers 154 or 164 provide pitch and/or attitude control.

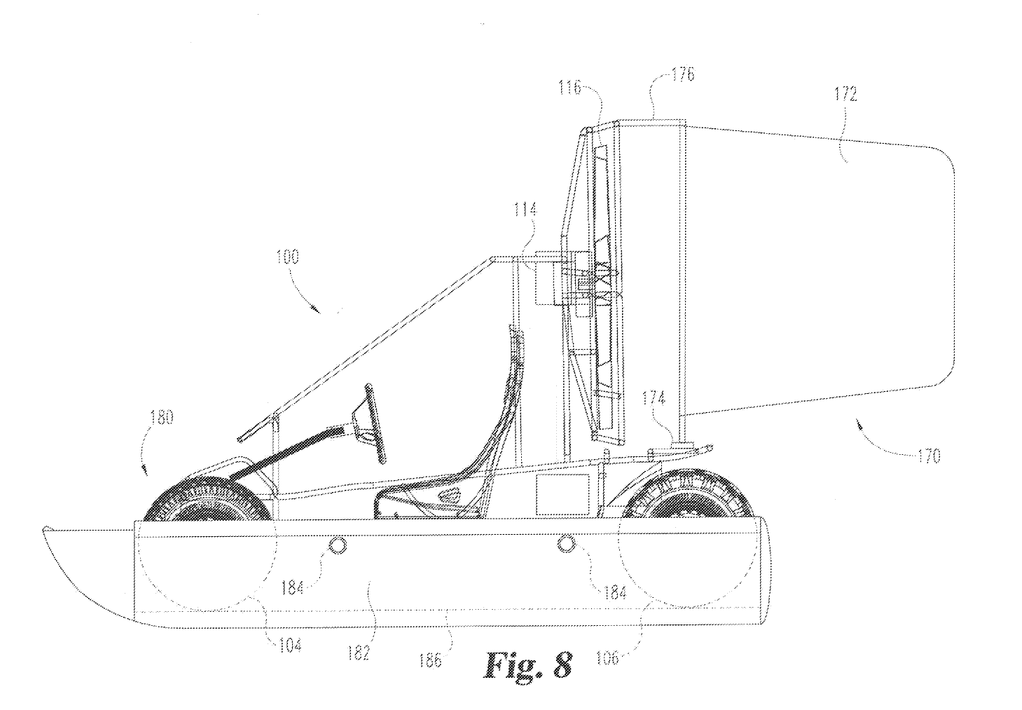

Referring to FIG. 8, vehicle 100 is illustrated with rudder assembly 170 and pontoon assembly 180 attached. Pontoon assembly 180 includes two pontoons 182 that are attached on either side of rear wheels 106. Pontoon assembly 180 may be attached to vehicle 100 in at least one of two disclosed methods. In the first, each pontoon 182 includes projections 184 that are constructed and arranged to extend into accessory mounts supports 120 on vehicle 100. In the other, pontoons 182 are affixed to each other by base 186 leaving room between pontoons 182 to drive vehicle 100 onto base 186. Once in position, front wheels 104 and rear wheels 106 may then be locked into position on base 186 by straps or other mechanical attachment means. Vehicle 100 can then be operated on water using fan 116 for thrust and rudder 172 for directional control.

In the illustrated embodiment, the combined lift capacity of wings 140 is approximately 2400 pounds (10.7 kN) of lift. While the design weight of vehicle 100 with wings 140 and either tail assembly 150 or rudder assembly 170 with canard assembly 160 attached is 650 pounds (295 kg). The design lift capacity of wings 140 far exceeds the lift capacity required to enter ground effect; however, designing excess lift capacity in wings 140 may allow use of comparably reduced thrust from fan 116 (and comparatively reduced airspeed while flying in ground effect). With 500 pounds (227 kg) of passengers and cargo capacity, the lift capacity of wings 140 is at least twice the maximum loaded weight of vehicle 100.

Engines 112 and 114 and fan 116 are configured with a specific wing 140 configuration so that fan 116 operating at maximum thrust provides insufficient velocity for vehicle 100 to enter ground effect flight (when operating on a substantially level surface). That is, in order to enter ground effect flight on a level surface, both engine 112 and engine 114 need to be operated together. Similarly, engine 112 operating alone on level ground provides insufficient velocity for vehicle 100 to enter ground effect flight. Engine 114, fan 116 and wings 140 are constructed and arranged to provide insufficient lift for vehicle 100 to exit ground effect flight and enter into free flight; however, once vehicle 100 reaches sufficient velocity to enter ground effect flight, fan 116 and engine 114 provides sufficient thrust for vehicle 100 to maintain flight in ground effect.

Vehicle 100 may operate as a ground vehicle using either engine 112 or engine 114 independently as power sources, or vehicle 100 may be operated with both engine 112 and engine 114 providing thrust. In the illustrated embodiment, engine 112 operating at maximum throttle propels vehicle 100 on level ground at approximately 35 MPH (56 km/hr). Similarly, engine 114 and fan 116 operating at maximum throttle alone propel vehicle 100 at approximately 32 MPH (51 km/hr) on level ground. Operating engine 112 and engine 114 together, both at maximum throttle, propel vehicle 100 at approximately 53 MPH (85 km/hr) on level ground. With wings 140 and either tail assembly 150 or canard assembly 160 and rudder assembly 170 attached with wings 140, vehicle 100 enters ground effect flight at approximately 40 MPH (64 km/hr). The maximum airspeed in ground effect flight with engine 114 with maximum throttle and fan 116 at maximum thrust is approximately 50 MPH (80 km/hr).

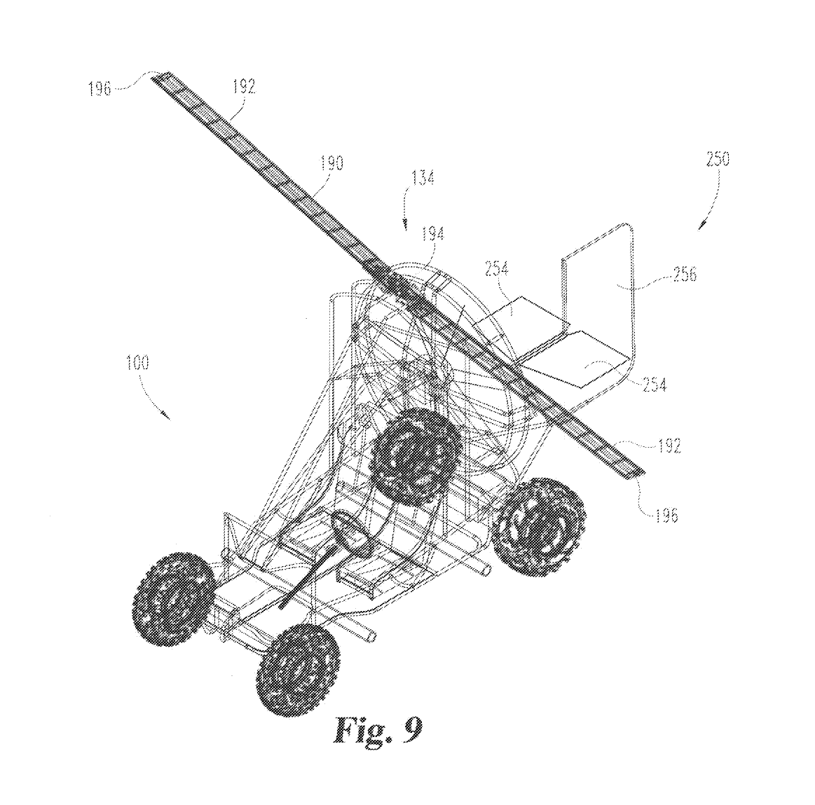

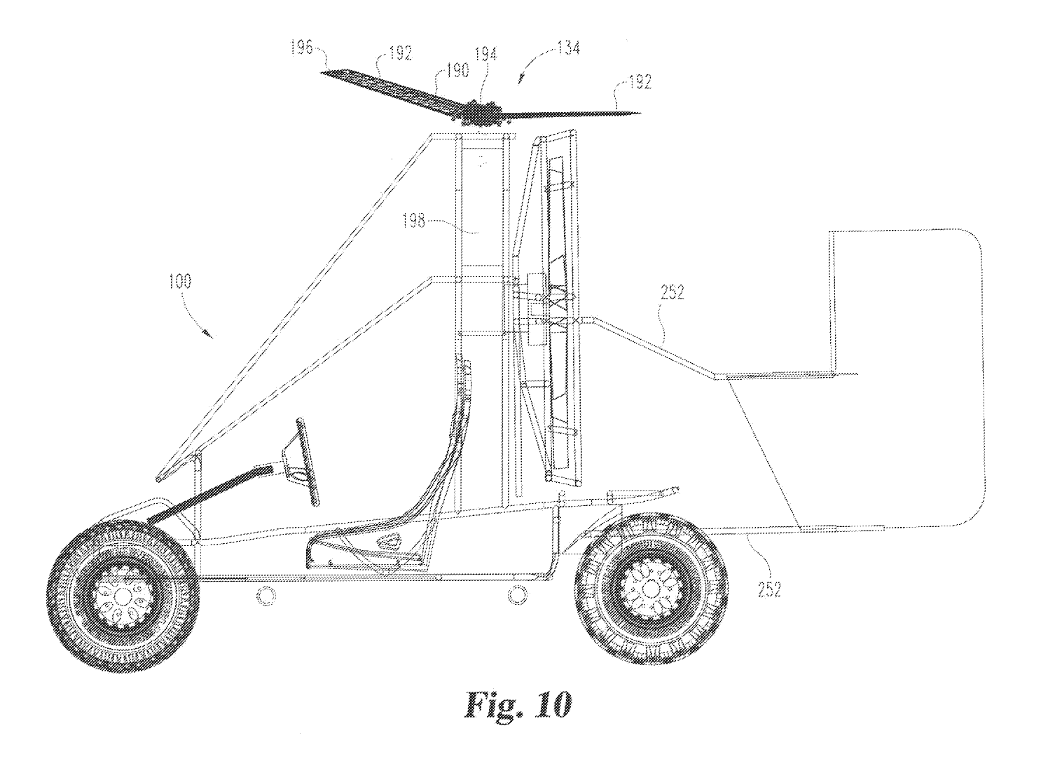

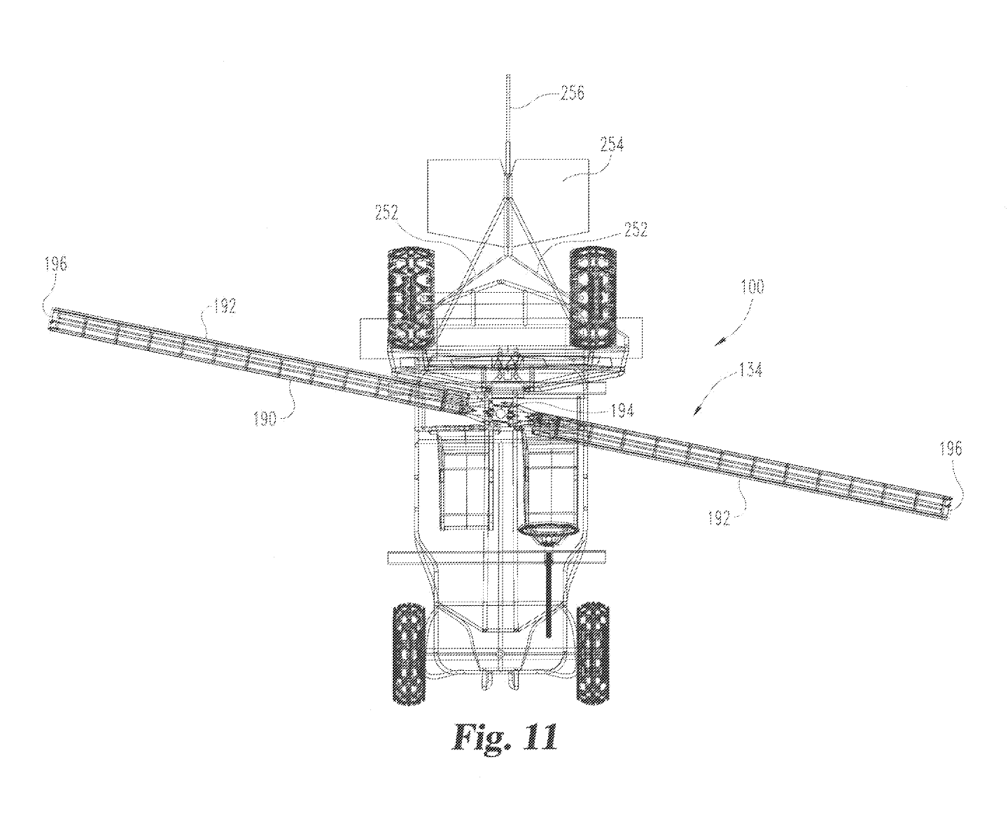

Referring to FIGS. 9-11, vehicle 100 is illustrated with flying kit 134 attached. Flying kit 134 includes rotor assembly 190 and tail assembly 250. Rotor assembly 190 includes tip jet rotors 192, rotor hub 194, jets 196 and engine 198. Engine 198 is a source of a propellant, for example compressed air or an energetic material such as hydrogen peroxide. Rotor hub 194 rotationally couples tip jet rotors 192 to vehicle 100 and provide for passage of the propellant from engine 198 to tip jet rotors 192. Tip jet rotors 192 define lifting rotors and include an internal passageway between rotor hub 194 and jet 196 for the passage of the propellant. Jets 196 define jet nozzles on the tip of tip jet rotors 192 that direct the propellant to generate thrust that rotates tip jet rotors 192 about rotor hub 194. In the case of compressed air, jets 196 direct the compressed air in the appropriate direction. In the case of an energetic material such as hydrogen peroxide, jets 196 may also generate a reaction with the energetic material to define a rocket engine that generates thrust to rotate the tip jet rotors. In this regard, jets 196 may also include a catalyst reactive with the propellant.

In the case of an energetic material propellant, the propellant may include one or more reactive substance. If more than one reactive substance is used, for example, a fuel and an oxidizer, the substances may be transferred to jets 196 separately or mixed, depending upon the nature of the reactive substances used.

Tail assembly 250 includes tail support 252, horizontal stabilizer 254 and rudder 256. Tail supports 252 couple horizontal stabilizer 254 to frame 102 and/or fan case 118. Rudder 256 pivots vertically and its relative pivot position is controlled by the operator (not illustrated). Any desired means to control rudder 256 may be used including, but not limited to, rudder pedals, lever, linkage by cable, a mechanical linkage and/or a motor driven fly-by-wire system with a motor driven rudder 256.

When flying vehicle 100 with flying kit 134, altitude is controlled by varying the output of engine 198 with a throttle (not illustrated). Forward motion is generated by fan 116 and engine 114 and direction of flight is controlled by rudder 256 combined with thrust from fan 116. Tip jet rotors do not place torque on the airframe, so no counter-rotation system such as a tail rotor is required.

This disclosure serves to illustrate and describe the claimed invention to aid in the interpretation of the claims and to enable a person skilled in the art to make and use the claimed invention. However, this disclosure is not restrictive in character because not every embodiment covered by the claims is necessarily illustrated and described. The claimed invention is not intended nor should it be limited to the disclosed embodiments, but is to be accorded the widest scope consistent with the principles and features disclosed herein. All changes and modifications that come within the scope of the claims are desired to be protected, not just those embodiments explicitly described.

I claim:

1. A vehicle comprising:
a chassis constructed and arranged to carry a person;
a first engine carried by the chassis;
a wheel coupled to the chassis, wherein the wheel is constructed and arranged to support the vehicle and to support movement of the vehicle over the ground;
a transmission coupling the first engine to the wheel such that the first engine powers rotation of the wheel to propel the vehicle in a forward direction on the ground;
a second engine;
a fan coupled to the chassis and the second engine such that the second engine powers rotation of the fan, wherein the fan is constructed and arranged to produce thrust that propels the vehicle in a forward direction;
two wings removable attached to the chassis;
a horizontal stabilized removablely attached to the chassis; and
a rudder, wherein the two wings, the second engine and the fan are constructed and arranged such that a maximum thrust generated by the second engine and the fan produces insufficient velocity for the vehicle when the vehicle is on substantially level ground for the wings to lift the vehicle off the ground, wherein the first engine and the wheel are constructed and arrange to provide additional velocity for the vehicle when the vehicle is on substantially level ground sufficient for the wings to lift the vehicle off the ground into ground-effect flight and wherein the second engine and the fan produce sufficient thrust to keep the vehicle in ground-effect flight once the vehicle is off the ground.

2. The vehicle of claim 1, wherein the first engine and the wheel are constructed and arranged to produce inadequate thrust for the vehicle to enter free flight.

3. The vehicle of claim 1, wherein the rudder is removablely attached to the chassis.

4. The vehicle of claim 1, wherein a lift capacity of the wings is at least twice a maximum loaded weight of the vehicle.

5. The vehicle of claim 1, wherein the wings are attached to the chassis proximate a bottom of the chassis.

6. The vehicle of claim 5, further comprising skid-arms position under a leading edge of each wing near an outer tip of each wing.

7. The vehicle of claim 1, wherein the wings are constructed and arranged with an airflow shape optimized for flight in ground effect.

8. The vehicle of claim 1, wherein the wings do not include elevator ailerons.

9. The vehicle of claim 1, wherein the vehicle is constructed and arranged to have a maximum airspeed in ground effect flight of approximately 80 km/hr.

10. The vehicle of claim 9, wherein the vehicle is constructed and arranged to enter ground effect flight at approximately 64 km/hr.

11. The vehicle of claim 10, wherein the vehicle is constructed and arranged such that the first engine operating alone propels the vehicle at a maximum ground velocity of approximately 56 km/hr.

12. The vehicle of claim 1, further comprising two pontoons removablely attachable to the chassis in place of the two wings.

13. The vehicle of claim 12, wherein the two pontoons further comprise a projection constructed and arranged to be received in an accessory mount support on the chassis.

14. The vehicle of claim 12, wherein the two pontoons further comprise a base assembly constructed and arranged to receive the chassis on top of the base assembly.

15. A vehicle comprising:
a chassis constructed and arranged to carry a person;
a first engine carried by the chassis;
a wheel coupled to the chassis, wherein the wheel is constructed and arranged to support the vehicle and to support movement of the vehicle over the ground;
a transmission coupling the first engine to the wheel such that the first engine powers rotation of the wheel to propel the vehicle in a forward direction on the ground;
a second engine;
a fan coupled to the chassis and the second engine such that the second engine powers rotation of the fan, wherein the fan is constructed and arranged to produce thrust that propels the vehicle in a forward direction;
two wings removable attached to the chassis proximate to a bottom of the chassis, wherein the wings are constructed and arranged with an airflow shape optimized for flight in ground effect;
a horizontal stabilized removablely attached to the chassis; and
a rudder, wherein a lift capacity of the wings is at least twice a maximum loaded weight of the vehicle.

16. The vehicle of claim 15, wherein the two wings, the second engine and the fan are constructed and arranged such that a maximum thrust generated by the second engine and the fan produces insufficient velocity for the vehicle when the vehicle is on substantially level ground for the wings to lift the vehicle off the ground, wherein the first engine and the wheel are constructed and arrange to provide additional velocity for the vehicle when the vehicle is on substantially level ground sufficient for the wings to lift the vehicle off the ground into ground-effect flight and wherein the second engine and the fan produce sufficient thrust to keep the vehicle in ground-effect flight once the vehicle is off the ground.

17. The vehicle of claim 16, wherein the first engine and the wheel are constructed and arranged to produce inadequate thrust for the vehicle to enter free flight.

18. The vehicle of claim 15, wherein the vehicle is constructed and arranged to have a maximum airspeed in ground effect flight of approximately 80 km/hr.

19. The vehicle of claim 18, wherein the vehicle is constructed and arranged to enter ground effect flight at approximately 64 km/hr.

20. The vehicle of claim 19, wherein the vehicle is constructed and arranged such that the first engine operating alone propels the vehicle at a maximum ground velocity of approximately 56 km/hr.
